(19) United States
(12) Patent Application Publication
(10) Pub. No.: US 2025/0282327 A1
(43) Pub. Date: Sep. 11, 2025

(54) DEVICE FOR CLEANING AN OPTICAL SURFACE OF AN OPTICAL SENSOR OF A VEHICLE, AND DETECTION SYSTEM

(71) Applicant: VALEO SYSTEMES D'ESSUYAGE, La Verriere (FR)

(72) Inventors: Yoann DOLLE, La Verriere (FR); William TERRASSE, La Verrière (FR); Aurélien COUAVOUX, La Verrière (FR); Loic ROUSSEL, La Verrière (FR); Guillaume BARRET, La Verrière (FR); Nicolas KUCHLY, La Verriere (FR)

(73) Assignee: VALEO SYSTEMES D'ESSUYAGE, La Verriere (FR)

(21) Appl. No.: 18/861,255

(22) PCT Filed: Apr. 26, 2023
(86) PCT No.: PCT/EP2023/061051

§ 371 Date: Oct. 29, 2024

(30) Foreign Application Priority Data
May 3, 2022 (FR) 2204187

(51) Int. Cl. B60S 1/56; B60S 1/52

(52) U.S. Cl. CPC B60S 1/56; B60S 1/52

(57) ABSTRACT

A device for cleaning an optical surface of an optical sensor of a vehicle. The device including a first and a second segment respectively having a cleaning fluid circulation channel and a connector, the first and second segments each including a cleaning fluid inlet and at least one fluid diffusion nozzle, the first segment and the second segment being configured to be attached to one another so as to form a circular arc, the connectors having complementary shapes and being configured to interact so as to make it possible to lock the first and second segments relative to one another in an axial direction and in a radial direction.

### TECHNICAL FIELD

The invention relates to a device for cleaning an optical surface of an optical sensor of a vehicle, and to a detection system comprising such a cleaning device.

### BACKGROUND OF THE INVENTION

Automotive vehicles are increasingly fitted with optical elements, such as optical position sensors. The function of the optical position sensors is to gather information about the area surrounding the vehicle, in particular to assist the driver in driving and/or maneuvering this vehicle. To this end, an optical sensor is commonly installed on the vehicle so as to collect information about the area surrounding the vehicle. However, such optical sensors are particularly exposed to dirt such as dirty water, dust or other types of spray. This dirt hinders the transmission and reception of information and can disrupt the operation of the optical sensor, or even stop it from operating.

The use of devices for cleaning an optical surface of optical elements so as to remove this dirt from them has been proposed. These cleaning devices have a complex structure and it may be the case that the cleaning device has a manufacturing defect. The problem is then that the whole of the device is rejected.

There is a need for a device for wiping an optical surface of an optical element of a vehicle that solves this problem.

### SUMMARY OF THE INVENTION

The aim of the invention is to provide a device for cleaning an optical surface of an optical sensor of a vehicle that stops all of the device being rejected if a manufacturing defect arises.

For this, the invention provides a device for cleaning an optical surface of an optical sensor of a vehicle, the device comprising a first segment having a first cleaning fluid circulation channel and a first connector, a second segment having a second cleaning fluid circulation channel and a second connector, the first and second segments each comprising a cleaning fluid inlet and at least one nozzle for diffusing the cleaning fluid toward the optical surface, the first segment and the second segment being configured to be attached to one another so as to form a circular arc defining an axial direction passing through the center of the circular arc and a radial direction along a radius of the circular arc, the first connector and the second connector having complementary shapes and being configured to interact so as to make it possible to lock the first and second segments relative to one another in the axial direction and in the radial direction.

According to a variant, the connectors of segments attached to one another form a detachable snap-fastening means.

According to a variant, the connectors comprise a projection on one of the segments and a bore in another segment, the engagement of the projection in the bore preventing the segments from moving in translation relative to one another in the radial direction and a tangential direction, which is orthogonal to the radial direction and axial direction.

According to a variant, the projection can be snap-fastened in the bore, the snap-fastening of the projection in the bore preventing the segments from moving in translation relative to one another in the axial direction.

According to a variant, the connectors additionally comprise pads and/or lugs on at least one of the segments that interact with the other segment and prevent the segments from rotating relative to one another about the axial direction.

According to a variant, the connectors comprise tabs on at least one of the segments that engage with the other segment and prevent the segments from moving in translation relative to one another in the axial direction.

According to a variant, the connectors additionally comprise lugs on at least one of the segments that engage with the other segment and prevent the segments from rotating relative to one another about the axial direction, and/or a stud on at least one of the segments and an orifice in the other segment, the engagement of the stud in the orifice and the snap-fastening of the projection in the bore preventing the segments from rotating relative to one another about the axial direction.

According to a variant, the connector of one of the segments comprises a tongue which engages in a receiving portion of the other connector of the other segment, the snap-fastening of the tongue in the receiving portion preventing the segments from moving in translation relative to one another in the tangential direction, radial direction and axial direction and about the axial direction.

According to a variant, the device comprises a passage for an attachment member for attaching the cleaning device to a sensor support, the passage going through the connectors.

According to a variant, the segments form an annular structure, the structure having two segments attached to one another in pairs, preferably having three segments attached to one another in pairs, preferably having four segments attached to one another in pairs.

According to a variant, at least some of the segments are identical modules.

The invention also relates to a detection system comprising an optical sensor of a vehicle and a cleaning device as described above, the device being configured to clean the optical surface of the optical sensor.

According to a variant, the optical sensor has a cylindrical optical surface, the segments forming an annular structure around at least one part of the circumference of the optical surface.

All of the preferred embodiments and all of the advantages of the cleaning device according to the invention can be transferred, mutatis mutandis, to the present detection system. The different embodiments can be taken in combination or considered in isolation.

### BRIEF DESCRIPTION OF DRAWINGS

Further features and advantages of the present invention will become apparent from reading the following detailed description, for the understanding of which reference will be made to the appended figures, in which:

FIG. 1 is a view of a cleaning device;

FIG. 2 is a view of a segment of the device in FIG. 1;

FIG. 3 is a view of an example of connectors;

FIG. 4 is a view of an example of connectors;

FIG. 5 is a view of an example of connectors;

FIG. 6 is a view of an example of connectors;

FIG. 7 is a view of an example of connectors.

The drawings in the figures are not to scale. Similar elements are generally denoted by similar references in the figures. In the context of this document, identical or analogous elements may bear the same references. Furthermore, the presence of reference numbers or letters in the drawings cannot be considered limiting, including when these numbers or letters are indicated in the claims.

### DETAILED DESCRIPTION OF THE INVENTION

The invention provides a device for cleaning an optical surface of an optical sensor of a vehicle. The device comprises a first segment having a first cleaning fluid circulation channel and a first connector. The device also comprises a second having a second cleaning fluid circulation channel and a second connector. The first and second segments each comprise a cleaning fluid inlet and at least one nozzle for diffusing the cleaning fluid toward the optical surface. The first segment and the second segment are configured to be attached to one another so as to form a circular arc. In addition, the first connector and the second connector have complementary shapes and are configured to interact so as to make it possible to lock the first and second segments relative to one another in an axial direction and in a radial direction. As a result, the cleaning device is formed of multiple segments attached to one another. This makes it possible to reject one segment independently of another if a defect arises on one of the segments. It is then not necessary to reject all of the device if one segment is faulty.

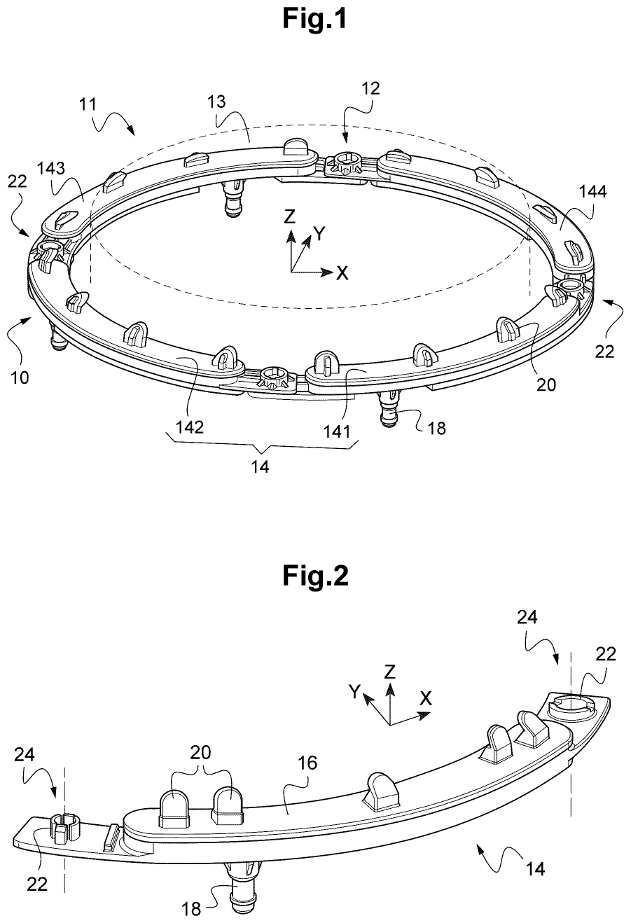

FIG. 1 shows a cleaning device 10. The cleaning device 10 may notably be used in a detection system 11 of a vehicle comprising an optical sensor 12. The optical sensor 12 makes it possible to collect information on the position of and the area surrounding the automotive vehicle, in particular to assist the driver in driving and/or maneuvering this vehicle. The optical sensor 12 is installed on the vehicle so as to collect information on the area to the front, rear and/or side of the vehicle: the optical sensor 12 is for example installed at the front end and/or at the rear end. The optical sensor 12 is for example a LIDAR, which stands for “light detection and ranging” or “laser imaging, detection, and ranging”.

The sensor 12 interacts with the surrounding area by means of an optical surface 13. It may be a protective surface between the optical element and the surrounding area. For example, it may be a surface of a pane fitted between the sensor and the surrounding area, or a surface of a casing which encloses a sensor (such as a face of a LIDAR casing). The surface may be opaque (to the visible wavelengths). The surface may be transparent to the emission and reception wavelengths of the sensor 12. It is also possible to envisage multiple sensors interacting with the surrounding area by means of a single optical surface.

The shape of the optical surface 13 can vary according to the location and use of the sensor 12 in the vehicle and depending on how crowded the sensor is. The optical surface 13 may have some portions which are rounded and others which are rectilinear. According to FIG. 1, the optical surface 13 has a cylindrical shape.

The device 10 comprises a plurality of segments 14, specifically at least two segments 141, 142. According to FIG. 1, the device comprises by way of example four segments 141, 142, 143, 144; it is conceivable that the device 10 comprises a different number of segments. The segments 14 are configured to be attached in pairs. For example, the first segment 141 and the second segment 142 are configured to be attached to one another.

The segments may be identical or have different shapes. The shape of the segments is therefore adapted to the shape and the surrounding area of the optical surface 13. The segments 14 form modules; the segments 14 are independent modules. In the device 10, at least some of the segments are identical modules; this makes it possible to assemble the device simply but also to replace faulty segments simply. This makes it easier to manufacture the device. According to FIG. 1, all the segments are identical modules.

The segments 14 have a shape which is elongate between two ends. The first segment 141 and the second segment 142 are configured to be attached to one another so as to form a circular arc. A circular arc is a portion of a curve that is delimited by two points of this curve; a circular arc is a portion of the circumference of a circle with a center and a radius. The circular arc defines an axial direction Z which passes through the center of the circular arc, a radial direction Y which is along a radius of the circular arc, and a tangential direction X which is tangential to the portion of a circle of the circular arc. The circular arc may extend in a plane, which is to say a two-dimensional space, but may also be shaped such that the circular arc is partially in a plane and extends in three dimensions. The specific shape of each segment 14 depends on the shape of the optical surface 13. At least some of the segments are in the form of a circular arc, such as the first segment 141 and the second segment 142. This makes it possible to at least partially get round the optical surface 13.

FIG. 2 shows an example of a segment 14. The segment 14 has the shape of a circular arc, as defined above. As mentioned, the circular arc formed by the segments 141 and 142 may extend in three dimensions, and one segment 14 may have a slope between its ends. In a bottom view, the segment 14 is still a circular arc. The shape of the segment also depends on the area surrounding the optical surface 13 and is adapted to how crowded the optical surface 13 is. The segments 14 may have a circular-arc shape which differs from one segment to the next. This makes it possible to adapt it to the shape and the surrounding area of the optical surface 13.

Some segments 14 may have a circular-arc shape and some segments may have a rectilinear shape or indeed any shape at all. The shape of the device is such that the segments face the optical surface 13. The optical surface 13 is at least partially surrounded by the device 10 (at least in the portions by means of which the one or more sensors 12 interact with the surrounding area). The device 10 may have a closed shape (as in FIG. 1) or an open shape. The device 10 may have a circular overall shape with the directions X, Y, Z that was defined above. According to FIG. 1, it is possible to envisage that the segments 14 form an annular structure. The annular structure (of 360°) may have two segments attached to one another in pairs (each segment representing 180°), or three segments attached to one another in pairs (each segment representing 120°), or four segments attached to one another in pairs (each segment representing 90°). According to FIG. 1, the segments 14 form a circle around the optical surface 13, which has a cylindrical shape. The directions X and Y are in the same plane (that of the device 10), with the tangential direction X extending tangentially to the circle and the radial direction Y extending radially toward the center of the circle; the axial direction Z is orthogonal to the directions X and Y, through the center of the circle. The direction Z may extend along the height of the optical surface 13.

The segments 14 each have a cleaning fluid circulation channel 16. The channel 16 in the segments is a flow duct with a hollow and elongate form, enabling passage of the fluid for cleaning the optical surface 13. The channel 16 follows the shape of the segment 14, which is to say a circular arc as described above. According to FIG. 2, the first segment 141 shown comprises a first circulation channel 16 and the second segment 142 has a second circulation channel 16. The same applies to any other additional segment 14. Each channel 16 extends over at least some of the length of the respective segment 14, but does not extend from one segment to the next; a channel 16 defines a flow duct specific to each segment 14. Since the channels 16 are independent of one another, the device may have an open shape, such as an open loop.

In addition, the segments 14 each comprise a cleaning fluid inlet 18 and at least one nozzle 20 for diffusing the cleaning fluid toward the optical surface 13. The inlet 18 is connected to a cleaning fluid distribution network and makes it possible to supply cleaning fluid to the channel 16. Each segment 14 therefore comprises its own fluid inlet 18; fluid is then supplied to each of the segments 14 independently. The inlet 18 may extend along an axis Z, but it is possible to envisage another shape, such as a curved shape, to adapt to the area surrounding the sensor. The channel 16 of each segment 14 then makes it possible to distribute cleaning fluid to the one or more fluid diffusion nozzles 20. Five nozzles 20 are shown by way of example on the segment 14 in FIG. 2; also by way of example, the segments 14 in FIG. 1 each have four nozzles 20. The segments have a number of nozzles 20 which is specific to them, depending on the location of the segments 14 in relation to the optical surface 13 and in relation to the portion of optical surface 13 that is to be cleaned. Similarly, the nozzles 20 are distributed over each segment 14 depending on the portion of optical surface 13 that is to be cleaned.

The segments 14 also have a connector 22. The first segment 141 has a first connector 22 and the second connector 142 has a second connector 22. The same applies to any additional segment 14. The segments 14 are configured to be attached in pairs, and depending on the segments 14, to form a circular arc. The segments 14 are attached to one another by way of their respective connector 22. The first connector 22 and the second connector 22 have complementary shapes and are configured to interact so as to make it possible to lock the first and second segments 141, 142 relative to one another in the axial direction Z and in the radial direction Y. As a result, the segments 141 and 142 are attached to one another so as to form the device 10. The interaction between the connectors 22 makes it possible to immobilize one segment relative to the other so as to make up the device 10. The locking of the segments 14 makes it possible to give the device 10 a one-piece nature so as to be able to subsequently assemble it in position in the vehicle. The device therefore comprises modular segments each having a connector, the interaction between which provides the one-piece nature and ensures easy assembly around the optical surface 13. In addition, the segments 14 are modular elements that can be replaced if a defect arises—notably when the segments are being assembled to one another. This makes it possible to correct the device 10 when it is being assembled without scrapping the device 10 entirely; all that is necessary is to replace the one or more defective segments.

The device 10 may have a number of segments that depends on the optical surface 13 to be cleaned. The segments 14 may then comprise two connectors 22, one connector 22 at each end of the segments 14. This makes it possible to join a segment 14 to two other, neighboring segments 14. According to FIG. 1, each segment 14 is joined to two neighboring segments 14 by its two connectors 22. The device 10 can thus form a closed loop. However, the device 10 may be an open loop, the connector 22 of an end segment 14 not being joined to a neighboring segment.

The connectors 22 may make it possible for two neighboring segments 14 to be detachably engaged. This makes it possible to repair the device 10 after it has been assembled and while it is being used—without scrapping all of the device 10. A faulty segment can be replaced. The connectors 22 may make it possible to snap-fasten two neighboring segments 14. In other words, the connectors 22 form a clip. This enables easy assembly of the connectors 22 with one another and detachable locking of the segments.

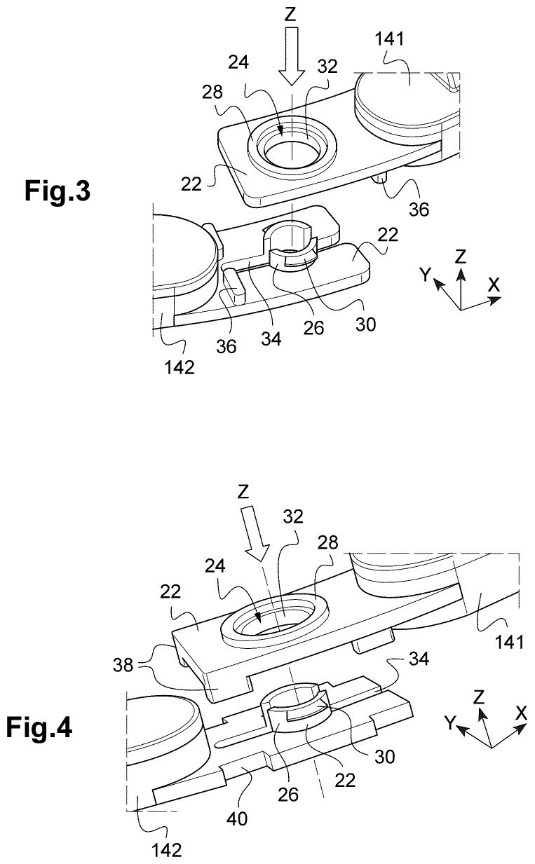

FIG. 3 to FIG. 7 show examples of connectors 22. The connectors 22 have complementary shapes for fixing one segment to the next.

FIG. 3 to FIG. 6 show the connectors 22 comprising a projection 26 on one of the segments and a bore 28 in another channel. The engagement of the projection 26 in the bore 28 prevents the segments 141, 142 from moving in translation relative to one another along the radial direction Y and the tangential direction X. The first and second connectors 22 interact so as to make it possible to lock the segments 141, 142 in relation to one another in a plane containing X and Y. The connectors 22 engage one in the other along the direction Z.

According to FIG. 3 and FIG. 4, the projection 26 can be snap-fastened in the bore 28, the snap-fastening of the projection 26 in the bore 28 preventing the segments 141, 142 from moving in translation relative to one another along the axial direction Z. As a result, the first and second connectors 22 interact so as to make it possible to lock the segments 141, 142 in relation to one another in the three directions X, Y, Z. The snap-fastening is obtained by shoulders 30 on the connector 22 of one of the segments 14 (the segment 142 in FIG. 3 and FIG. 4) that engage with a reduction in diameter 32 on the other of the segments 14 (the segment 141 in FIG. 3 and FIG. 4). The shoulders 30 and the reduction in diameter 32 form a clip, ensuring easy engagement. Once the shoulders 30 are engaged with the reduction in diameter 32, the segments are secured. Furthermore, a slot 34 in one of the segments 14 (the segment 142 in FIG. 3 and FIG. 4) makes the engagement of the connectors 22 detachable. A pressure exerted along the direction Y of the connector 22 against the slot 34 makes it possible to remove the connectors 22 from one another. This makes it possible to dismount the two segments 141, 142 and to replace one of them if required.

According to FIG. 3 and FIG. 4, the connectors 22 additionally comprise pads 36 and/or lugs 38 on at least one of the segments 14 that interact with the other segment and prevent the segments 14 from rotating relative to one another about the axial direction Z. This gives the device 10 a one-piece nature, avoiding deformation while the device is being mounted in the vehicle and throughout the service life of the device 10.

More specifically, FIG. 3 presents pads 36 on the connector 22 of each of the segments 141, 142. The pads 36 on one segment 14 abut the end of the other segment 14. The abutment of the end of one segment 14 against the pads 36 prevents the segments from rotating relative to one another about the direction Z. For example, the connectors 22 of each of the segments 141, 142 have two pads 36 on a face that faces toward the other segment. The two pads 36 on one of the connectors 22 abut the end of the other segment 14 and prevent the segments from rotating relative to one another about the direction Z.

FIG. 4 presents lugs 38 on at least one of the connectors 22. The lugs 38 on one segment 14 engage with the connector 22 of the other segment. The other segment may have slots 40 through which the lugs 38 engage. The engagement of the lugs 38 with the other segment prevents the segments from rotating relative to one another about the direction Z. For example, the connector 22 of the segment 141 has four lugs 38 around the bore 28 on a face that faces toward the other segment 142. The four lugs 38 engage in the corresponding slots 40 of the other segment 142 and prevent the segments from rotating relative to one another about the direction Z.

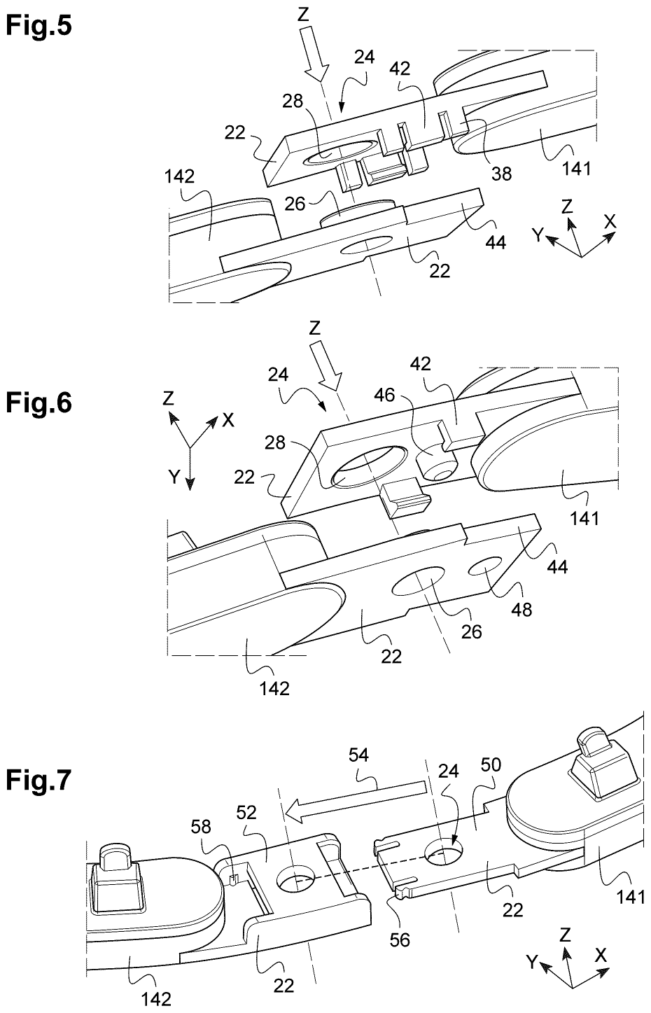

According to FIG. 5 and FIG. 6, the projection 26 (essentially hidden behind the connector 22 in FIG. 6) can engage in the bore 28, with the engagement of the projection 26 in the bore 28 preventing the segments 141, 142 from moving in translation relative to one another along the directions X and Y. In addition, the interaction between the connectors 22 is elastic, and the connectors 22 may comprise tabs 42 on at least one of the segments 14 (the segment 141 in FIG. 5 and FIG. 6) that engage with the other segment 14 (the segment 142 in FIG. 5 and FIG. 6) and prevent the segments from moving in translation relative to one another along the axial direction Z. As a result, the first and second connectors 22 interact so as to make it possible to prevent the segments 141, 142 from moving relative to one another in the three directions X, Y, Z. The tabs 42 form a clip, ensuring easy engagement. The tabs 42 also make the engagement of the connectors 22 detachable. Once the tabs 42 are engaged with the other segment, the segments are detachably secured. A spacing between the tabs 42 along the direction Y makes it possible to remove the connectors 22 from one another. This makes it possible to dismount the two segments 141, 142 and to replace one of them if required. Furthermore, the other segment may have a notch 44 (the segment 142 in FIG. 5 and FIG. 6) in which the tabs 42 can engage.

More specifically, FIG. 5 presents lugs 38 on at least one of the connectors 22. The lugs 38 on one segment 14 engage with the other segment. The lugs 38 can engage in the notch 40 of the other segment. The engagement of the lugs 38 with the other segment prevents the segments from rotating relative to one another about the axial direction Z. For example, the connector 22 of the segment 141 has four lugs 38, in pairs on either side of the tabs 42 on a face that faces toward the other segment 142. The four lugs 38 engage in the corresponding notch 40 of the other segment 142 and prevent the segments from rotating relative to one another about the axial direction Z. The lugs 38 give the device 10 a one-piece nature, avoiding deformation while the device is being mounted in the vehicle and throughout the service life of the device 10.

FIG. 6 presents a stud 46 on at least one of the segments 14 (for example the segment 141 in FIG. 6) and an orifice 48 in the other segment 14 (for example the segment 141 in FIG. 6). The engagement of the stud 46 in the orifice 48 and the snap-fastening of the projection 26 in the bore 28 prevent the segments from rotating relative to one another about the axial direction Z. This gives the device 10 a one-piece nature, avoiding deformation while the device is being mounted in the vehicle and throughout the service life of the device 10.

According to FIG. 7, the connector 22 of one of the segments 14 (for example, the segment 141 according to FIG. 7) comprises a tongue 50. The other segment 14 (for example, the segment 142 according to FIG. 7) comprises a receiving portion 52. The tongue 50 can engage in the receiving portion 52, the snap-fastening of the tongue 50 in the receiving portion 52 preventing the segments from moving in translation relative to one another along the tangential direction X, radial direction Y and axial direction Z. This gives the device 10 a one-piece nature, avoiding deformation while the device is being mounted in the vehicle and throughout the service life of the device 10. As a result, the first and second connectors 22 interact so as to make it possible to lock the segments 141, 142 in relation to one another along the tangential direction X, radial direction Y and axial direction Z and about the axial direction Z. The connectors 22 engage one in the other along the direction X, which is marked by the arrow 54.

To ensure the two segments 141 and 142 are prevented from moving in translation relative to one another once the tongue 50 is engaged in the receiving portion 52, the connector 22 provided with the tongue 50 may comprise clamps 56 with a slot, each interacting with a rib 58 of the other connector 22. This makes it possible to detachably snap-fasten the connectors 22. A pressure exerted along the direction Y of the clamps 56 against the slot makes it possible to remove the connectors 22 from one another. This makes it possible to dismount the two segments 141, 142 and to replace one of them if required.

The segments 14 may comprise a passage 24 for an attachment member for attaching the cleaning device 10 to a sensor support 12, the passage 24 going through the connectors 22. The passage 24 through a respective connector 22 is an interface for attaching the device 10 to the support; it is not necessary to provide other attachment means, such as attachment tabs, and this simplifies the device 10. In addition, the attachment member of the device 10 extending through the connectors 22 makes it possible to enhance the locking of the segments in relation to one another and avoids the risk of the segments 14 coming apart during use owing to vibrations in the vehicle. According to FIG. 3 to FIG. 6, the passage 24 goes through the projection 26 and the bore 28; once the projection 26 is engaged in the bore, the passage 24 of each connector 22 is coaxial with the passage 24 of the other connector. According to FIG. 7, the passage 24 goes through the tongue 50 and the receiving portion 52; once the tongue 50 is engaged in the bore 52, the passage 24 of each connector 22 is coaxial with the passage 24 of the other connector. This makes it possible to insert an attachment member 10 of the device in the area surrounding the sensor 12. The attachment member is for example a screw or a pad forming a clip.

The invention also relates to the detection system 11 shown in FIG. 1, comprising the optical sensor 12 of a vehicle and the cleaning device 10. The device 10 is configured to clean the optical surface 13 of the optical sensor. According to one embodiment, the optical surface 13 of the optical sensor 12 is cylindrical, the segments 14 forming an annular structure around at least one part of the circumference of the optical surface. The advantages described of the device 10 apply to the system 11.

The present invention has been described in relation to specific embodiments, which have purely illustrative value and should not be considered limiting. In general, it will be obvious to a person skilled in the art that the present invention is not limited to the examples illustrated and/or described above.

What is claimed is:

1. A device for cleaning an optical surface of an optical sensor of a vehicle, the device comprising:
a first segment having a first cleaning fluid circulation channel and a first connector,
a second segment having a second cleaning fluid circulation channel and a second connector,
the first and second segments each including cleaning fluid inlet and at least one nozzle for diffusing the cleaning fluid toward the optical surface,
the first segment and the second segment being configured to be attached to one another so as to form a circular arc defining an axial direction passing through the center of the circular arc and a radial direction along a radius of the circular arc,
the first connector and the second connector having complementary shapes and being configured to interact so as to make it possible to lock the first and second segments relative to one another in the axial direction and in the radial direction.

2. The device as claimed in claim 1, wherein the connectors of segments attached to one another form a detachable snap-fastening means.

3. The device as claimed in claim 1, wherein the connectors include a projection on one of the segments and a bore in another segment, the engagement of the projection in the bore preventing the segments from moving in translation relative to one another in the radial direction and a tangential direction, which is orthogonal to the radial direction and axial direction.

4. The device as claimed in claim 3, wherein the projection can be snap-fastened in the bore, the snap-fastening of the projection in the bore preventing the segments from moving in translation relative to one another in the axial direction.

5. The device as claimed in claim 3, wherein the connectors additionally include pads and/or lugs on at least one of the segments that interact with the other segment and prevent the segments from rotating relative to one another about the axial direction.

6. The device as claimed in claim 3, wherein the connectors include tabs on at least one of the segments that engage with the other segment and prevent the segments from moving in translation relative to one another in the axial direction.

7. The device as claimed in claim 6, wherein the connectors additionally comprise
lugs on at least one of the segments that engage with the other segment and prevent the segments from rotating relative to one another about the axial direction, and/or
a stud on at least one of the segments and an orifice in the other segment, the engagement of the stud in the orifice and the snap-fastening of the projection in the bore preventing the segments from rotating relative to one another about the axial direction.

8. The device as claimed in claim 1, wherein the connector of one of the segments includes a tongue which engages in a receiving portion of the other connector of the other segment, the snap-fastening of the tongue in the receiving portion preventing the segments from moving in translation relative to one another in the tangential direction, radial direction and axial direction and about the axial direction.

9. The device as claimed in claim 1, further comprising a passage for an attachment member for attaching the cleaning device to a sensor support, the passage going through the connectors.

10. The device as claimed in claim 1, wherein the segments form an annular structure, the structure having two segments attached to one another in pairs.

11. The device as claimed in claim 1, wherein at least some of the segments are identical modules.

12. A detection system comprising an optical sensor of a vehicle and a cleaning device, the cleaning, device being configured to clean the optical surface of the optical sensor and including a first segment having a first cleaning fluid circulation channel and a first connector, a second segment having a second cleaning fluid circulation channel and a second connector, the first and second segments each including a cleaning fluid inlet and at least one nozzle for diffusing the cleaning fluid toward the optical surface, the first segment and the second segment being configured to be attached to one another so as to form a circular arc defining an axial direction passing through the center of the circular arc and a radial direction along a radius of the circular arc, the first connector and the second connector having complementary shapes and being configured to interact so as to make it possible to lock the first and second segments relative to one another in the axial direction and in the radial direction.

13. The system as claimed in claim 12, wherein the optical sensor has a cylindrical optical surface the segments forming an annular structure around at least one part of the circumference of the optical surface.

14. The device as claimed in claim 1, wherein the segments form an annular structure, the structure having three segments attached to one another in pairs.

15. The device as claimed in claim 1, wherein the segments form an annular structure, the structure having four segments attached to one another in pairs.
